(19) United States
(12) Patent Application Publication
(10) Pub. No.: US 2026/0001452 A1
(43) Pub. Date: Jan. 1, 2026

(54) PIVOTING ASSEMBLY FOR VEHICLE SEAT

(71) Applicant: FAURECIA Sièges d'Automobile, NANTERRE (FR)

(72) Inventor: Gérald GAROTTE, BELLOU EN HOULME (FR)

(21) Appl. No.: 19/242,149

(22) Filed: Jun. 18, 2025

(30) Foreign Application Priority Data
Jun. 26, 2024 (FR) 2406869

(51) Int. Cl. B60N 2/14

(52) U.S. Cl. CPC B60N 2/146

(57) ABSTRACT

A pivoting assembly for a vehicle seat includes: a lower plate configured to be connected to a vehicle floor, an upper plate pivotally mounted with respect to the lower plate about a first axis, an articulation mechanism where the upper plate is pivotally mounted with respect to the lower plate about the first axis, the articulation mechanism having a locked state wherein it prevents pivoting of the upper plate with respect to the lower plate and an unlocked state wherein it allows free pivoting of the upper plate with respect to the lower plate about the first axis, an electric actuator, and a transmission configured to toggle the articulation mechanism between the locked state and the unlocked state.

### PRIORITY CLAIM

This application claims priority to French Patent Application No. FR2406869, filed Jun. 26, 2024, which is expressly incorporated by reference herein.

### BACKGROUND

The present disclosure relates to a vehicle seat pivoting assembly. The present description also relates to a seat comprising such a pivoting assembly and to a vehicle, in particular a motor vehicle, comprising such a seat.

### SUMMARY

According to the present disclosure, a pivoting assembly for a vehicle seat comprises:
a lower plate configured to be connected to a vehicle floor,
an upper plate pivotally mounted with respect to the lower plate about a first axis extending in a first direction,
an articulation mechanism interposed between the lower plate and the upper plate and by means of which the upper plate is pivotally mounted with respect to the lower plate about the first axis, the articulation mechanism having a locked state wherein it prevents pivoting of the upper plate with respect to the lower plate and an unlocked state wherein it allows free pivoting of the upper plate with respect to the lower plate about the first axis,
wherein it comprises an electric actuator and a transmission, the actuator and the transmission being configured to toggle the articulation mechanism between the locked state and the unlocked state.

The transmission may comprise a control member pivotally mounted with respect to the upper plate, the actuator and the transmission being configured to toggle the articulation mechanism between the locked state and the unlocked state by pivoting the control member about the first axis between a locked position and an unlocked position, respectively.

The electric actuator can comprise a fixed part secured to the upper plate and a movable part capable of translational movement with respect to the fixed part in a second direction which is perpendicular to the first direction, the transmission being connected to the movable part so that a translational movement in the second of the movable part of the electric actuator causes the control member to pivot about the first axis.

The transmission can comprise a rod extending in the second direction, the rod being connected to the movable part of the electric actuator at a first end portion and connected to the control member at a second end portion.

The second end portion of the rod may be hook-shaped, the control member comprising a pin extending along a second axis parallel to the first axis and whereupon the second end portion of the rod is engaged.

The articulation mechanism may comprise:
a first flange secured to the lower plate,
a second flange secured to the upper plate,
a locking device in an interior space defined by the first flange and the second flange, the locking device comprising one or more locking beads each having an exterior toothing, the first flange comprising an annular interior toothing oriented radially inwards and located opposite the exterior toothing of each locking bead, each locking bead being adapted to be moved radially between a locking position wherein the exterior toothing engages the interior toothing of the first flange and an unlocking position wherein the interior toothing is spaced apart from the interior toothing of the first flange,
a sleeve pivotally mounted about the first axis with respect to the second flange, the sleeve being adapted to move the one or more locking beads between their locking position and their unlocking position by pivoting about the first axis.

The control member can be pivotally secured to the sleeve about the first axis.

The control member may comprise an upper part located above the upper plate, the upper part of the control member preferably having a bell shape which includes a disc portion and an annular portion at the periphery of the disc portion.

The upper plate may comprise one or more tabs extending in the first direction toward the upper part of the control member, the upper part of the control member may comprise one or more grooves extending in the first direction and having a circular arc shape about the first axis, each tab of the upper plate being received in an associated groove of the one or more grooves of the upper part of the control member, each tab being adapted to abut, on each side in the pivoting direction, a lateral edge of the associated groove to limit pivoting of the control member with respect to the upper plate when the control member pivots about the first axis.

The control member can comprise a support tab which bears on the upper plate in the first direction.

According to another aspect, a vehicle seat is proposed comprising the pivoting assembly as described above. The seat can comprise a control device configured to control the electric actuator.

According to another aspect, a vehicle is described comprising a seat as described above.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 comprises FIGS. 1A and 1B.

FIGS. 1A and 1B show a seat with a vertical pivoting function according to a comparative.

FIG. 2 is a schematic perspective view of a pivoting assembly according to the present description, intended for a seat with a vertical pivot function.

FIG. 3 is a larger-scale view of the zone in dotted lines in FIG. 2.

FIG. 4 is a partial schematic cross sectional view of the pivoting assembly of FIG. 2.

FIG. 5 is a larger-scale, partially exploded view of the dotted area in FIG. 2, wherein a control member of the device is separated from an articulation mechanism.

FIG. 6 is an isolated schematic perspective view of the control member.

FIG. 7 is an isolated schematic cross sectional perspective view of the control member and a sleeve of the articulation mechanism.

FIG. 8 is an isolated schematic cross sectional view of the articulation mechanism in a locked state.

FIG. 9 is an isolated schematic front view of the articulation mechanism.

FIG. 10 is a partial schematic cross sectional view of the pivoting assembly of FIG. 2 which more particularly shows a stop device.

### DETAILED DESCRIPTION

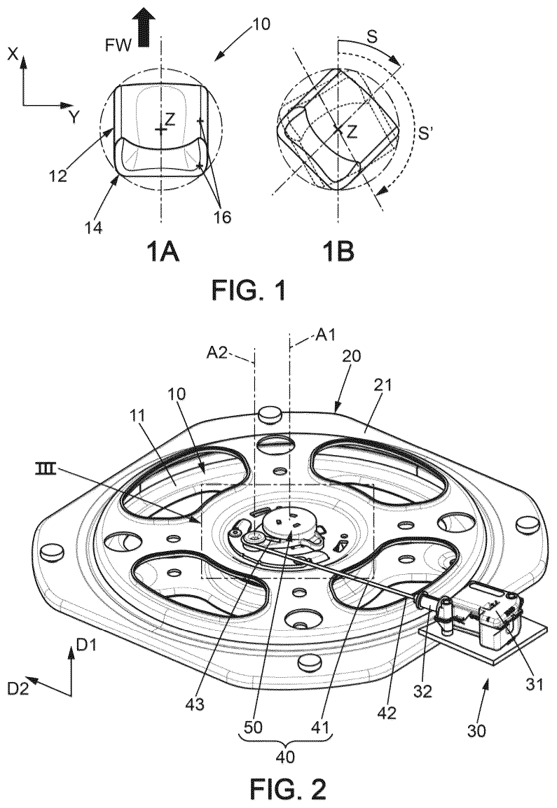

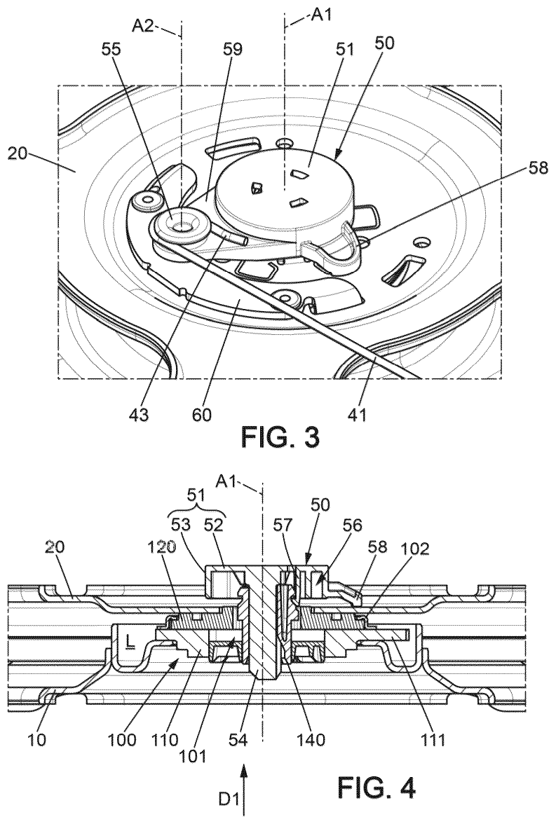

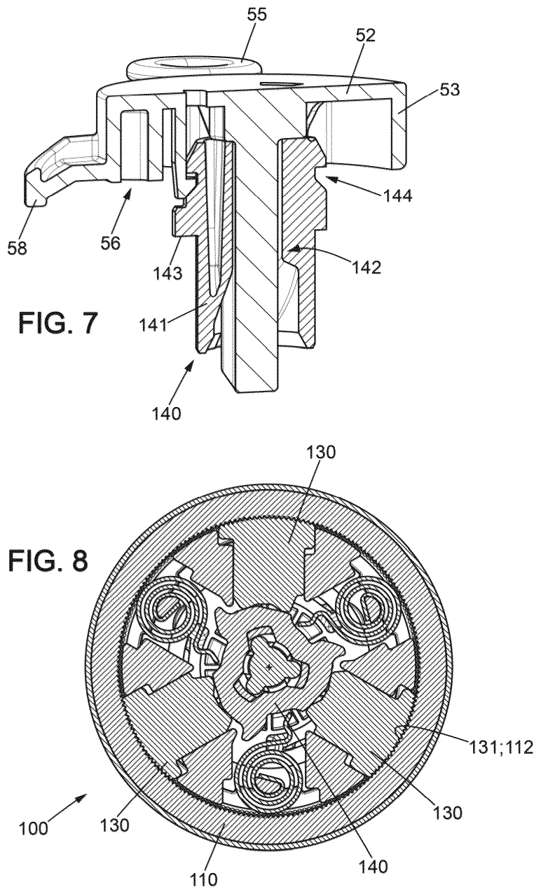

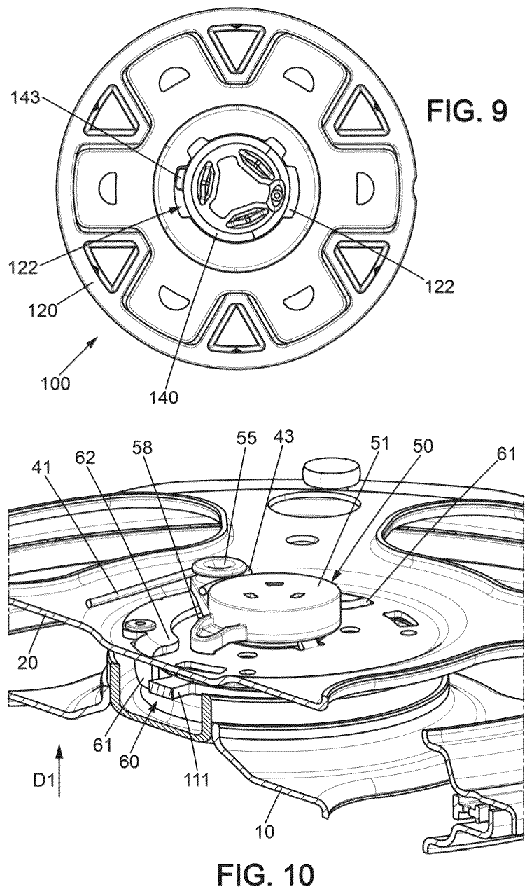

Referring to FIGS. 2 to 10, a pivoting assembly for a vehicle seat with a vertical pivot function as described with reference to FIG. 1 is now described.

The pivoting assembly for a vehicle seat comprises a lower plate 10 configured to be connected to a vehicle floor and an upper plate 20 pivotally mounted with respect to the lower plate 10 about a first axis A1 extending in a first direction D1.

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation of the figures or the seat in its normal position of use.

In the following, the longitudinal direction X means the longitudinal direction X of the seat. The longitudinal direction X of the seat is considered to be the same as the longitudinal direction X of the motor vehicle wherein the seat is mounted. This longitudinal direction X corresponds to the normal direction FW in which the vehicle advances. The longitudinal direction X is preferably horizontal. The transverse direction Y is the transverse direction Y of the seat. The transverse direction Y of the seat thus corresponds to the transverse Y or lateral direction of the motor vehicle. This transverse direction Y corresponds to a direction perpendicular to the normal direction of travel of the vehicle. The transverse direction Y is preferably horizontal. Finally, the vertical direction Z is the direction perpendicular to the direction to the longitudinal direction and the transverse direction Y. The vertical direction Z coincides with the direction of the earth's gravitational field.

The first direction D1 may be close to, or even coincide with, the vertical direction Z. Thus, the first axis A1 may be close to, or even coincide with, a vertical axis extending in the vertical direction Z.

The qualifiers such as “radial” or “circumferential” orientation are defined in reference to the first axis A1 unless otherwise specified. A radial direction is a direction perpendicular to the direction of the first axis A1. A circumferential direction, at a point away from the first axis A1, corresponds to a direction perpendicular to the first direction D1 and the radial direction. Moreover, unless otherwise specified, the adjectives “interior”, “inner”, “exterior” and “outer” are used with reference to a radial direction so that the interior/inner part, that is to say radially interior/inner part, of an element is closer to the first axis A1 than the exterior/outer part, that is to say radially exterior/outer part, of the same element.

The lower plate 10 can be configured to be connected to the vehicle floor directly or via a slideway mechanism adapted to move the seat in the longitudinal direction.

An angular pivoting amplitude of the upper plate 20 about the first axis A1 with respect to the lower plate 10 is at least equal to 90°, preferably at least equal to 180°, and even more preferably at least equal to 360°. In certain configurations, it is possible to obtain a multi-turn solution.

The lower plate 10 and/or the upper plate 20 may each be made in a single piece, that is to say monobloc. The lower plate 10 and/or the upper plate 20 may each comprise a main wall 11; 21 substantially perpendicular to the first direction D1. In other words, the lower plate 10 and/or the upper plate 20 may each comprise a main wall 11; 21 which extends in a plane perpendicular to the first direction D1.

The upper plate 20 and the lower plate 10 can define a housing L therebetween in the first direction D1. In other words, the housing L can be delimited on either side by the lower plate 10 and the upper plate 20 in the first direction D1. The articulation mechanism 100 can be arranged, in whole or in part, in the housing L, that is to say between the interior plate and the upper plate 20 in the first direction D1.

The pivoting assembly further comprises an articulation mechanism 100 interposed between the lower plate 10 and the upper plate 20 and whereby the upper plate 20 is mounted pivoting with respect to the lower plate 10 about the first axis A1. The articulation mechanism 100 thus connects the upper plate 20 to the lower plate 10. The articulation mechanism 100 has a locked state wherein it prevents pivoting of the upper plate 20 with respect to the lower plate 10, and an unlocked state wherein it allows free pivoting of the upper plate 20 with respect to the lower plate 10 about the first axis A1. In other words, in the locked state of the articulation mechanism 100, the upper plate 20 is fixed with respect to the lower plate 10.

The articulation mechanism will be described in more detail later.

The pivoting assembly further comprises an electric actuator 30 and a transmission 40. Remarkably, the actuator and the transmission 40 are configured to toggle the articulation mechanism 100 between the locked state and the unlocked state. Toggling the articulation mechanism 100 between the locked state and the unlocked state can thus be achieved more easily via the electric actuator 30.

The transmission 40 may comprise a control member 50, as shown more particularly in FIGS. 4 to 7. The control member can be pivotally mounted with respect to the upper plate 20. Toggling the articulation mechanism 100 between the locked state and the unlocked state can be achieved by pivoting the control member 50 about the first axis A1 between a locked position and an unlocked position, respectively.

More particularly, the electric actuator 30 can comprise a fixed part 31 secured to the upper plate 20 and a movable part 32 able to move in translation with respect to the fixed part 31 in a second direction D2 which is perpendicular to the first direction D1. The transmission 40 can be connected to the movable part 32 so that a translational movement in the second of the movable part 32 of the electric actuator 30 causes the control member 50 to pivot about the first axis A1. The fixed part 31 can be rigidly attached to a peripheral edge of the upper plate 20. The actuator can be adapted to be electrically connected to a power supply unit, such as a vehicle battery. The second direction D2 may be close to, or even coincide with, a horizontal direction. The second direction D2 can be varied based on the pivoting of the upper plate 20 with respect to the lower plate 10 about the first axis A1. In other words, the second direction D2 may comprise a component in the longitudinal direction X and/or in the transverse direction Y depending on the angular position of the upper plate 20 about the first axis A1.

The transmission 40 can comprise a rod 41 extending in the second direction, the rod 41 being connected to the movable part 32 of the electric actuator 30 at a first end portion 42 and connected to the control member 50 at a second end portion 43. The second end portion 43 of the rod 41 can be hook-shaped. Thus, the control member 50 may comprise a pin 55 extending along a second axis A2 parallel to the first axis A1 and whereupon the second end portion 43 of the rod 41 is engaged. In other words, the second end portion 43 of the hook-shaped rod 41 can be engaged, that is to say hooked, on the pin 55. The pin 55 may comprise an annular groove wherein the second end portion 43 of the hook-shaped rod 41 is engaged. This limits or even prevents disengagement of the hook-shaped second end portion 43 of the pin 55.

The articulation mechanism 100 is now described in more detail, with particular reference to FIGS. 4, 8 and 9.

The articulation mechanism 100 may be of the discontinuous type. The articulation mechanism 100 can be non-motorized, that is, with manual action. In this sense, when the articulation mechanism 100 is in its unlocked state, the second flange 120 can pivot freely about the first axis A1 with respect to the first flange 110. Subsequently, in the unlocked state of the articulation mechanism 100, the upper plate 20 can pivot freely about the first axis A1 with respect to the second flange 120. An example of a discontinuous articulation mechanism 100 with locking beads 130 can be found in document FR2977204, to which reference may be made.

The articulation mechanism 100 may comprise a first flange 110 secured to the lower plate 10 and a second flange 120 secured to the upper plate 20. The first flange 110 and the second flange 120 can be rigidly attached to the upper plate 20 and the lower plate 10, respectively, by welding, screwing, bolting, gluing or any other suitable attachment method. The first flange 110 and the second flange 120 can be substantially circular in shape. The first flange 110 and the second flange 120 can be joined together by an exterior ring 102, preferably crimped, and thus delimiting therebetween an interior space 101 in the first direction D1.

The articulation mechanism 100 may also comprise a locking device. The locking device can be arranged in the interior space 101 defined by the first flange 110 and the second flange 120. The locking device may comprise one or more locking beads 130, each with an exterior toothing 131. Thus, the first flange 110 may comprise an annular interior toothing 112 oriented radially inwards and located opposite the exterior toothing 131 of each locking bead 130. It is therefore understood that the interior toothing 112 of the first flange 110 is arranged in the interior space 101.

Each locking bead 130 can be adapted to be moved radially between a locking position wherein the exterior toothing 131 engages the interior toothing 112 of the first flange 110 and an unlocking position wherein the interior toothing 112 is spaced apart from the interior toothing 112 of the first flange 110. When each locking bead 130 is in the unlocking position, the articulation mechanism 100 is in the unlocked state. Conversely, when at least one of the one or more locking beads 130 is in the locking position, and preferably when each locking bead 130 is in the locking position, the articulation mechanism 100 is in the locked state. The second flange 120 may comprise guides for receiving and guiding the locking beads 130 in translation radially with respect to the first axis A1. The articulation mechanism 100 can be the to be “discontinuous” in that it allows locking in a large number of discrete positions according to the pitch of the teeth of the ring gear.

The articulation mechanism 100 may further comprise a sleeve 140 pivotally mounted about the first axis A1 with respect to the second flange 120, the sleeve 140 being adapted to move the one or more locking beads 130 between their locking position and their unlocking position by pivoting about the first axis A1.

The sleeve 140 may comprise a portion arranged in the interior space 101 defined by the first flange 110 and the second flange 120 and which cooperates, directly or indirectly, with the one or more locking beads 130 to move them between their locking position and their unlocking position. The sleeve 140 can extend in the first direction D1 through the central hole 121 of the second flange 120 and a central hole 121 of the upper plate 20, so that an upper end portion of the sleeve 140 is arranged above the upper plate 20, that is, on the side opposite the lower plate 10.

The sleeve 140 may comprise a tubular wall 141 extending along the first axis A1. The tubular wall 141 can define a passage 142 along the first axis A1.

The sleeve 140 may comprise one or more tabs 143 extending radially, in particular from the tubular wall 141. The second flange 120 may comprise a central hole 121, in particular centered on the first axis A1, defining an edge from which extend, radially outwards and circumferentially about the first axis A1, one or more slots 122. Each tab 143 of the sleeve 140 can be received in an associated slot 122 of the one or more slots 122 of the second flange 120. When the sleeve 140 pivots about the first axis A1, each tab 143 can abut, on either side in the pivoting direction, on a lateral edge of the associated slot 122 to limit pivoting of the sleeve 140 with respect to the second flange 120.

The control member 50 can be pivotally secured to the sleeve 140 about the first axis A1. The control member 50 can be fitted into the sleeve 140 of the articulation mechanism 100. For this purpose, the control member 50 may comprise a shaft 54 extending along the first axis A1 and received in the sleeve 140 in a form-fitting manner so as to secure the control member 50 and the sleeve 140 pivotally about the first axis A1. More particularly, the shaft 54 of the control member 50 can be received in the tubular wall 141 of the sleeve 140. In other words, the shaft 54 of control member 50 can extend through the passage 142 defined by the tubular wall 141 of the sleeve 140.

The control member 50 may comprise an upper part 51 located above the upper plate 20, the upper part 51 of the control member 50 preferably having a bell shape which includes a disc portion 52 and an annular portion at the periphery of the disc portion 52. In this sense, the upper part 51 of the control member 50 can be arranged on a side of the upper plate 20 opposite the lower plate 10.

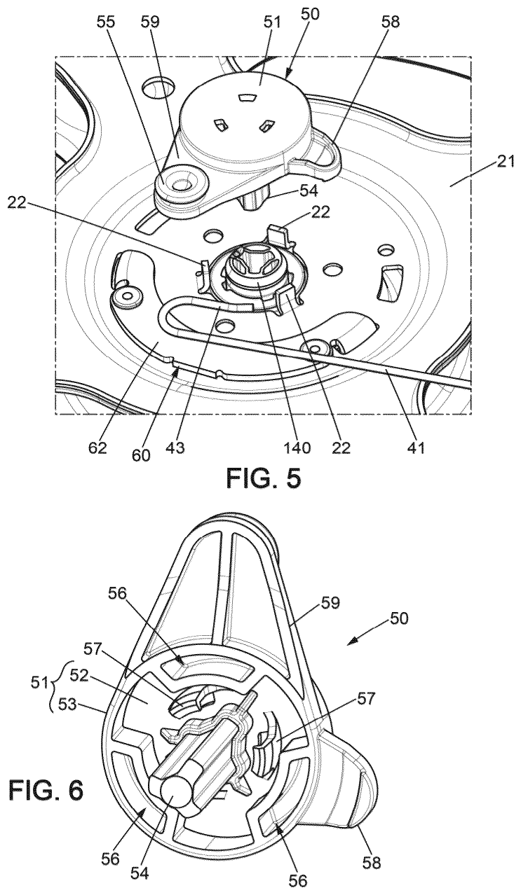

Visible in FIG. 5, the upper plate 20 may comprise one or more tabs 22 extending in the first direction D1 toward the upper part 51 of the control member 50. In a complementary manner, the upper part 51 of the control member 50 may comprise one or more grooves 56 extending in the first direction D1 and having a circular arc shape about the first axis A1. Each tab 22 of the upper plate 20 can be received in an associated groove 56 among the one or more grooves 56 of the upper part 51 of the control member 50. Thus, each tab 22 can abut, on either side in the direction of pivoting, on a lateral edge of the associated groove 56 to limit pivoting of the control member 50 with respect to the upper plate 20 when the control member 50 pivots about the first axis A1. The angular travel of the control member 50 is thus limited when pivoting between the locking position and the unlocking position. Each groove 56 of the upper part 51 of the control member 50 can be formed at the annular portion 53, in particular by a double wall of the annular portion 53. Each tab 22 of the upper plate 20 can extend in the first direction D1, from the main wall 21 of the upper plate 20, in a direction away from the lower plate 10.

The control member 50 can be secured to the sleeve 140 in translation in the first direction D1. More particularly, the upper part 51 of the control member 50 can be secured to the sleeve 140 in translation in the first direction D1. To this end, the sleeve 140 may comprise an annular groove 144, located in particular at the upper end portion of the sleeve 140 which is arranged above the upper plate 20. The annular groove 144 can be arranged on an outer face of the tubular wall 141 of the sleeve 140. The control member 50 may comprise one or more clipping tabs 57, the ends of which are intended to be received by clipping, or elastic interlocking, in the annular groove 144 of the sleeve 140. The control member 50 can thus be clipped, or elastically fitted, onto the sleeve 140.

The control member 50 can also comprise a support tab 58 which bears on the upper plate 20 in the first direction D1. The bearing in the first direction D1 between the support tab 58 and the upper plate 20 limits, or even prevents, any inclination of the support member with respect to the upper plate 20 and therefore with respect to the first axis A1, which would prevent it from pivoting correctly about the first axis A1. The support tab 58 can bear on a face of the upper plate 20 opposite the lower plate 10. The support tab 58 can be connected to the upper part 51 of the control member 50. The support tab 58 can be configured to slide over the upper plate 20 as the support member pivots about the first axis A1 with respect to the upper plate 20.

The control member 50 may comprise a support 59 for the pin 55. The support 59 can be connected to the upper part 51.

The control member 50 can be made, in whole or in part, in a single piece. In this sense, the upper part 51, the shaft 54, the support tab 58, the pin 55 and/or the support 59 can be monobloc.

With reference to FIG. 10, the pivoting assembly may comprise a stop device 60 configured to limit pivoting of the upper plate 20 with respect to the lower plate 10 about the first axis A1 to a predefined angular amplitude.

The stop device 60 can be rigidly attached to the upper plate 20. In this sense, pivoting the upper plate 20 about the first axis A1 causes the stop device 60 to pivot about the first axis A1. The stop device 60 may comprise at least one tongue 61 extending in the first direction D1 between the lower plate 10 and the upper plate 20. The first flange 110 of the articulation mechanism 100 may comprise at least one radially outwardly extending detent 111. The at least one tongue 61 can be configured to abut on the detent 111 of the first flange 110 when the upper plate 20 pivots about the first axis A1.

According to a variant not shown, the at least one tongue 61 can comprise a single tongue 61 capable of abutting, on either side in the pivoting direction, on the detent 111 of the first flange 110. According to this variant, the angular pivoting amplitude about the first axis A1 with respect to the lower plate 10 is substantially equal to 360°.

Alternatively, according to the variant shown in FIG. 10, the at least one tongue 61 may comprise a first tongue 61 and a second tongue 61 of the stop device 60, each able to come into abutment on the detent 111 of the first flange 110 when the upper plate 20 pivots about the first axis A1, respectively in a first direction and a second direction about the first axis A1. According to this variant, the angular pivoting amplitude about the first axis A1 with respect to the lower plate 10 is equal to the angular sector about the first axis A1 delimited by the first tongue 61 and the second tongue 61 and wherein the detent 111 of the first flange 110 is located.

The stop device 60 may comprise a central part 62 whereby the stop device 60 is attached to the upper plate 20. Each tongue 61 can extend in the first direction D1 from a respective end of the central part 62. The central part 62 can be shaped like a circular arc about the first axis A1. The central part 62 of the stop device 60 can be located above the upper plate 20. The upper plate 20 may comprise at least one hole 23 for the passage of the at least one tongue 61 through the upper plate 20.

The seat with vertical pivoting function, which comprises the pivoting assembly as described above, can comprise a control device configured to control the electric actuator 30.

The control device can be adapted to move the movable part 32 of the actuator with respect to the fixed part 31. The seat can comprise a control connection connecting the electric actuator 30 to the control device. All or part of the control connection can be wired, for example by means of an electrical cable. Alternatively, or in addition, all or part of the control connection can be wireless, for example by means of a wireless telecommunication device.

The control device can be mounted in the seat. The control device can be located on a squab trim of the seat, on a backrest trim of the seat and/or on an armrest of the seat.

The control device may comprise one or more buttons, for example of the single pushbutton or double pushbutton type. Alternatively, or in addition, the control device may comprise a piezoelectric element.

In this way, the control device can be easily accessed by a seat user.

The seat as described above can be installed in a vehicle, for example a motor vehicle. The control device can be mounted in the vehicle, in particular remotely from the seat. For example, the control device can be located on a vehicle dashboard, a vehicle door or a vehicle ceiling.

In transport vehicles, as shown in FIGS. 1A and 1B, the possibility of being able to pivot a comparative seat 10 to obtain a lounge-type configuration, that is, at least one seat 10 oriented in a position other than forward (represented by arrows S and S′ in FIG. 1B), has already been proposed. The possibility of using a vertical pivot movement to facilitate the entry and exit of (a) passenger(s) in a vehicle when wide door access is not available may be used.

In addition, in the context of more or less advanced driving delegation situations using the autonomous driving functions of the vehicle, not only the passengers but also the driver may prefer a seat 10 position which does not directly face the road, and varied and very different seat 10 orientations may be taken advantage of inside the passenger compartment.

A comparative vehicle seat with a pivoting function with a vertical axis, the pivoting assembly of which comprises a base configured to be connected to the floor of the vehicle, and a rotating ring mounted on the base by means of an articulation mechanism, interposed between the base and the rotating ring and whereupon a seat squab armature is intended to be attached.

According to a comparative embodiment, the rotating ring pivots with respect to the base by manual action on the part of a user. In other words, the articulation mechanism is non-motorized. To this end, the assembly comprises a control lever intended to be operated by the seat user in order to toggle the articulation mechanism between a locked state, wherein it prevents pivoting of the rotating ring with respect to the base, and an unlocked state, wherein it allows pivoting of the rotating ring with respect to the base.

However, depending on the vehicle wherein the seat is installed, such a control lever may be difficult to access. Additionally, in some cases, the control lever can be difficult to operate.

Proposed is a pivoting assembly for a vehicle seat comprising:
a lower plate configured to be connected to a vehicle floor,
an upper plate pivotally mounted with respect to the lower plate about a first axis extending in a first direction,
an articulation mechanism interposed between the lower plate and the upper plate and by means of which the upper plate is pivotally mounted with respect to the lower plate about the first axis, the articulation mechanism having a locked state wherein it prevents pivoting of the upper plate with respect to the lower plate and an unlocked state wherein it allows free pivoting of the upper plate with respect to the lower plate about the first axis,
characterized in that it comprises an electric actuator and a transmission, the actuator and the transmission being configured to toggle the articulation mechanism between the locked state and the unlocked state.

The transmission may comprise a control member pivotally mounted with respect to the upper plate, the actuator and the transmission being configured to toggle the articulation mechanism between the locked state and the unlocked state by pivoting the control member about the first axis between a locked position and an unlocked position, respectively.

The electric actuator can comprise a fixed part secured to the upper plate and a movable part capable of translational movement with respect to the fixed part in a second direction which is perpendicular to the first direction, the transmission being connected to the movable part so that a translational movement in the second of the movable part of the electric actuator causes the control member to pivot about the first axis.

The transmission can comprise a rod extending in the second direction, the rod being connected to the movable part of the electric actuator at a first end portion and connected to the control member at a second end portion.

The second end portion of the rod may be hook-shaped, the control member comprising a pin extending along a second axis parallel to the first axis and whereupon the second end portion of the rod is engaged.

The articulation mechanism may comprise:
a first flange secured to the lower plate,
a second flange secured to the upper plate,
a locking device in an interior space defined by the first flange and the second flange, the locking device comprising one or more locking beads each having an exterior toothing, the first flange comprising an annular interior toothing oriented radially inwards and located opposite the exterior toothing of each locking bead, each locking bead being adapted to be moved radially between a locking position wherein the exterior toothing engages the interior toothing of the first flange and an unlocking position wherein the interior toothing is spaced apart from the interior toothing of the first flange,
a sleeve pivotally mounted about the first axis with respect to the second flange, the sleeve being adapted to move the one or more locking beads between their locking position and their unlocking position by pivoting about the first axis.

The control member can be pivotally secured to the sleeve about the first axis.

The control member may comprise an upper part located above the upper plate, the upper part of the control member preferably having a bell shape which includes a disc portion and an annular portion at the periphery of the disc portion.

The upper plate may comprise one or more tabs extending in the first direction toward the upper part of the control member, the upper part of the control member may comprise one or more grooves extending in the first direction and having a circular arc shape about the first axis, each tab of the upper plate being received in an associated groove of the one or more grooves of the upper part of the control member, each tab being adapted to abut, on each side in the pivoting direction, a lateral edge of the associated groove to limit pivoting of the control member with respect to the upper plate when the control member pivots about the first axis.

The control member can comprise a support tab which bears on the upper plate in the first direction.

According to another aspect, a vehicle seat is proposed comprising the pivoting assembly as described above. The seat can comprise a control device configured to control the electric actuator.

A pivoting assembly for a vehicle seat, comprising:
a lower plate (10) configured to be connected to a vehicle floor,
an upper plate (20) pivotally mounted with respect to the lower plate (10) about a first axis (A1),
an articulation mechanism (100) by means of which the upper plate (20) is pivotally mounted with respect to the lower plate (10) about the first axis (A1), the articulation mechanism (100) having a locked state wherein it prevents pivoting of the upper plate (20) with respect to the lower plate (10) and an unlocked state wherein it allows free pivoting of the upper plate (20) with respect to the lower plate (10) about the first axis (A1),
an electric actuator (30) and a transmission (40) configured to toggle the articulation mechanism (100) between the locked state and the unlocked state.

1. A pivoting assembly for a vehicle seat, comprising:
a lower plate configured to be connected to a vehicle floor,
an upper plate pivotally mounted with respect to the lower plate about a first axis extending in a first direction,
an articulation mechanism interposed between the lower plate and the upper plate and by means of which the upper plate is pivotally mounted with respect to the lower plate about the first axis, the articulation mechanism having a locked state wherein it prevents pivoting of the upper plate with respect to the lower plate and an unlocked state wherein it allows free pivoting of the upper plate with respect to the lower plate about the first axis,
wherein it comprises an electric actuator and a transmission configured to toggle the articulation mechanism between the locked state and the unlocked state.

2. The pivoting assembly of claim 1, wherein the transmission comprises a control member pivotally mounted with respect to the upper plate, the actuator and the transmission being configured to toggle the articulation mechanism between the locked state and the unlocked state by pivoting the control member about the first axis between a locked position and an unlocked position, respectively.

3. The pivoting assembly of claim 1, wherein the electric actuator comprises a fixed part secured to the upper plate and a movable part capable of translational movement with respect to the fixed part in a second direction which is perpendicular to the first direction, the transmission being connected to the movable part so that translational movement in the second of the movable part of the electric actuator causes the control member to pivot about the first axis.

4. The pivoting assembly of claim 1, wherein the transmission comprises a rod extending in the second direction, the rod being connected to the movable part of the electric actuator at a first end portion and connected to the control member at a second end portion.

5. The pivoting assembly of claim 1, wherein the second end portion of the rod is hook-shaped, the control member comprising a pin extending along a second axis parallel to the first axis and whereupon the second end portion of the rod is engaged.

6. The pivoting assembly of claim 2, wherein the articulation mechanism comprises:
a first flange secured to the lower plate,
a second flange secured to the upper plate,
a locking device in an interior space defined by the first flange and the second flange, the locking device comprising one or more locking beads each having an exterior toothing, the first flange comprising an annular interior toothing oriented radially inwards and located opposite the exterior toothing of each locking bead, each locking bead being configured to be moved radially between a locking position wherein the exterior toothing engages the interior toothing of the first flange and an unlocking position wherein the interior toothing is spaced apart from the interior toothing of the first flange,
a sleeve pivotally mounted about the first axis with respect to the second flange, the sleeve being configured to move the one or more locking beads between their locking position and their unlocking position by pivoting about the first axis,
and wherein the control member is pivotally secured to the sleeve about the first axis.

7. The pivoting assembly of claim 2, wherein the control member comprises an upper part located above the upper plate, the upper part of the control member preferably having a bell shape which includes a disc portion and an annular portion at the periphery of the disc portion.

8. The pivoting assembly of claim 1, wherein the upper plate comprises one or more tabs extending in the first direction toward the upper part of the control member, the upper part of the control member may comprise one or more grooves extending in the first direction and having a circular arc shape about the first axis, each tab of the upper plate being received in an associated groove of the one or more grooves of the upper part of the control member, each tab being configured to abut, on each side in the pivoting direction, a lateral edge of the associated groove to limit pivoting of the control member with respect to the upper plate when the control member pivots about the first axis.

9. The pivoting assembly of claim 2, wherein the control member comprises a support tab which bears on the upper plate in the first direction.

10. A vehicle seat comprising the pivoting of claim 1, the seat comprising a control device configured to control the electric actuator.
